(19) United States
(12) Patent Application Publication
(10) Pub. No.: US 2023/0226432 A1
(43) Pub. Date: Jul. 20, 2023

(54) DISTANCE RECOMMENDATION DEVICE FOR GOLF, CAPABLE OF GENERATING RECOMMENDED DISTANCE AT THIRD LOCATION

(71) Applicant: RNDUS CO., LTD., Seoul (KR)

(72) Inventor: Kyu-Shik JUNG, Seongnam-si (KR)

(73) Assignee: RNDUS CO., LTD., Seoul (KR)

(21) Appl. No.: 18/009,986

(22) PCT Filed: Mar. 22, 2021
(86) PCT No.: PCT/KR2021/003476

§ 371 Date: Dec. 13, 2022

(30) Foreign Application Priority Data
Oct. 26, 2020 (KR) 10-2020-0139473

(51) Int. Cl. A63B 71/06

(52) U.S. Cl. CPC A63B 71/0622; A63B 2102/32

(57) ABSTRACT

A distance recommendation device for golf is proposed. As a method for providing a recommended distance from a ball to a target at a third location by the distance recommendation device for the golf, there is provided a distance recommendation method that includes obtaining position information of the ball positioned in each hole, obtaining position information of the target positioned in each hole, and generating a recommended shot distance from the ball to the target on the basis of the obtained information.

### TECHNICAL FIELD

The present disclosure relates to a distance recommendation device for golf and capable of generating a recommended distance at a third location and, more particularly, to a distance measurement device capable of recommending a shot distance between a golf ball and a target even at a point distant away from the golf ball or the target.

### BACKGROUND ART

Recently, as golf facilities such as screen golf courses and indoor golf driving ranges increase, golf is gradually developing as a popular sport in South Korea. In particular, as the golf population increases, the number of golfers who go out and play on golf courses is also increasing.

When playing a round on the course, after hitting a golf ball far, a golfer gets on a cart and moves near a position where the golf ball fell. The golfer in the cart roughly estimates a distance between the golf ball and a target, selects a specific club from among various clubs in the cart, and then takes the corresponding club and walks to the golf ball.

However, when the golf ball is far from a position of the cart, the distance from the golf ball to the target and an attack method may not be known in detail, so it is common for the golfer to move to the position of the golf ball while carrying two or three clubs selected through a rough guess.

Meanwhile, from golf spectators' perspectives, they watch a golf game near a lane where carts can pass, and since the distance between the golf ball and the target in the golf course may not be accurately known, obtaining of information during the viewing may be limited.

Accordingly, there is a need for a technique that allows measuring a target distance in detail from a golf ball to a target even at a third location other than a position of the golf ball.

### DISCLOSURE

### Technical Problem

An objective of the present disclosure is to solve the problems of the related art.

Another objective of the present disclosure is to enable a user to accurately obtain a target distance from a golf ball to a target at a third location other than a position of the golf ball or the target.

A yet another objective of the present disclosure is to enable golf game spectators to obtain distance information between a golf ball and a target and target distance information for an accurate shot, from the golf game spectators' perspectives as well.

The objectives of the present disclosure are not limited to the objectives mentioned above, and other objectives not mentioned herein will be clearly understood from the following description.

### Technical Solution

According to an exemplary embodiment of the present disclosure for achieving the above objectives, there is provided a distance recommendation method for golf, as a method for providing a recommended distance from a ball to a target at a third location by a distance recommendation device for the golf, the method including: (a) obtaining position information of the ball positioned in each hole; (b) obtaining position information of the target positioned in each hole; and (c) generating a recommended shot distance from the ball to the target on the basis of the obtained information.

Step (a) may include calculating a horizontal distance to the ball on the basis of measurement information comprising a straight-line distance from a current position to the ball and an inclination to the ball, step (b) may include calculating a horizontal distance to the target on the basis of measurement information comprising a straight-line distance from the current position to the target and an inclination to the target, and step (c) may include calculating, relative to the current position, a horizontal distance between the ball and the target on the basis of measurement information on an angle between the ball and the target, the horizontal distance to the ball, and the horizontal distance to the target.

Step (c) may further include generating the recommended distance for sending the ball to the target on the basis of a vertical distance from the ball to the target and the horizontal distance between the ball and the target, the vertical and horizontal distances being respectively calculated on the basis of the straight-line distance and inclination to the ball and the straight-line distance and inclination to the target.

Step (a) may include confirming absolute position information of the ball, and step (b) may include confirming absolute position information of the target.

According to another exemplary embodiment of the present disclosure, there is provided a distance recommendation device for golf, the device including: a calculation unit for characteristics up to a ball configured to obtain position information of the ball positioned in each hole; a calculation unit for characteristics up to a target configured to obtain position information of the target positioned in each hole; and a distance recommendation unit configured to generate a recommended shot distance from the ball to the target on the basis of the obtained information.

### Advantageous Effects

According to the exemplary embodiment of the present disclosure, the user may accurately obtain the target distance from the ball to the target at the third location other than the position of the ball or the target.

According to the exemplary embodiment of the present disclosure, since the golf game spectators are able to obtain the distance information between the ball and the target and the target distance information for the accurate shot, more interesting viewing may be possible from the golf game spectators' perspectives as well.

### DESCRIPTION OF DRAWINGS

FIG. 1 is a view illustrating an internal configuration of a distance recommendation device for golf according to an exemplary embodiment of the present disclosure.

FIG. 2 is a view illustrating a method of calculating respective horizontal distances to a ball and a target according to the exemplary embodiment of the present disclosure.

FIG. 3 is a view illustrating a method of generating a recommended distance for sending the ball to the target according to the exemplary embodiment of the present disclosure.

### MODE FOR INVENTION

In the detailed description of the present disclosure described below, reference is made to the accompanying drawings, which show by way of illustrating specific exemplary embodiments in which the present disclosure may be implemented. These exemplary embodiments are described in sufficient detail to enable those skilled in the art to implement the present disclosure. It should be understood that the various exemplary embodiments of the present disclosure are different, but are not necessary to be mutually exclusive. For example, specific shapes, structures, and characteristics described herein may be implemented in other exemplary embodiments without departing from the spirit and scope of the present disclosure in relation to one exemplary embodiment. In addition, it is to be understood that a position or arrangement of individual components in each disclosed exemplary embodiment may be changed without departing from the spirit and scope of the present disclosure. Accordingly, the detailed description to be described below is not intended to be taken in a limiting sense, and the scope of the present disclosure is limited only by the appended claims, along with all scopes equivalent to those claimed by the claims, when properly described. Like reference numerals in the drawings refer to the same or similar functions over several aspects.

Hereinafter, in order to enable those skilled in the art to easily implement the present disclosure, various preferred exemplary embodiments of the present disclosure will be described in detail with reference to the accompanying drawings.

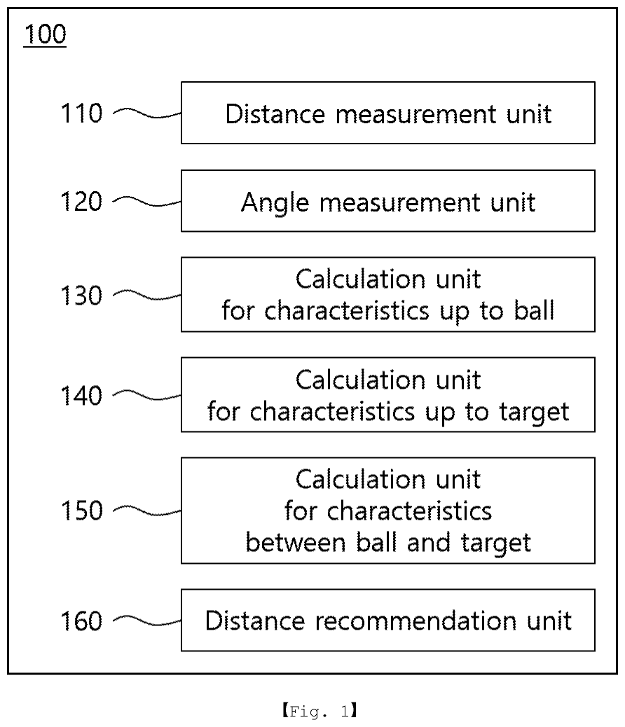

FIG. 1 is a view illustrating an internal configuration of a distance measurement device for golf according to the exemplary embodiment of the present disclosure.

Referring to FIG. 1, the distance recommendation device 100 for golf according to the exemplary embodiment may be configured to include a distance measurement unit 110, an angle measurement unit 120, a calculation unit 130 for characteristics up to a ball, a calculation unit 140 for characteristics up to a target, a calculation unit 150 for characteristics between a ball and a target, and a distance recommendation unit 160.

At least some of the distance measurement unit 110, angle measurement unit 120, calculation unit 130 for characteristics up to the ball, calculation unit 140 for characteristics up to the target, calculation unit 150 for characteristics between the ball and the target, distance recommendation unit 160 may be program modules or hardware components, which are capable of communicating with an external device. Such program modules or hardware components may be included in the distance recommendation device 100 or other device capable of communicating with the distance recommendation device 100 in the forms of operating systems, application program modules, and other program modules, and may be physically stored in various known storage devices. Meanwhile, such program modules or hardware components include, but are not limited to, routines, subroutines, programs, objects, components, data structures, and the like, which perform specific tasks or execute specific abstract data types and will be described according to the present disclosure.

The distance measurement unit 110 according to the exemplary embodiment may include a laser light-emitting unit, and may perform a function of target distance measurement by measuring a time when a laser beam is emitted to the target and the emitted laser beam is reflected and returned by the target thereafter and multiplying the measured time and the speed of the laser beam. In addition, the distance measurement unit 110 may include a GPS-based distance measurement unit or a distance measurement module measuring a distance to another target.

The distance measurement unit 110 according to the exemplary embodiment of the present disclosure measures respective distances, to a golf ball and a target, from a user's position, that is, a position of the distance recommendation device 100.

The angle measurement unit 120 according to the exemplary embodiment may be implemented in a form of a gyro sensor or the like, and performs a function of measuring an inclination angle of the distance recommendation device 100 with respect to a horizontal plane, that is, an inclination angle from a current position to a target when the distance recommendation device 100 is disposed to face the specific target. In addition, the angle measurement unit 120 may also measure, relative to a third point, an angle between a first point and a second point, when the first point and the second point are viewed relative to the third point. To this end, the angle measurement unit 120 may additionally include an acceleration sensor or a geomagnetic sensor.

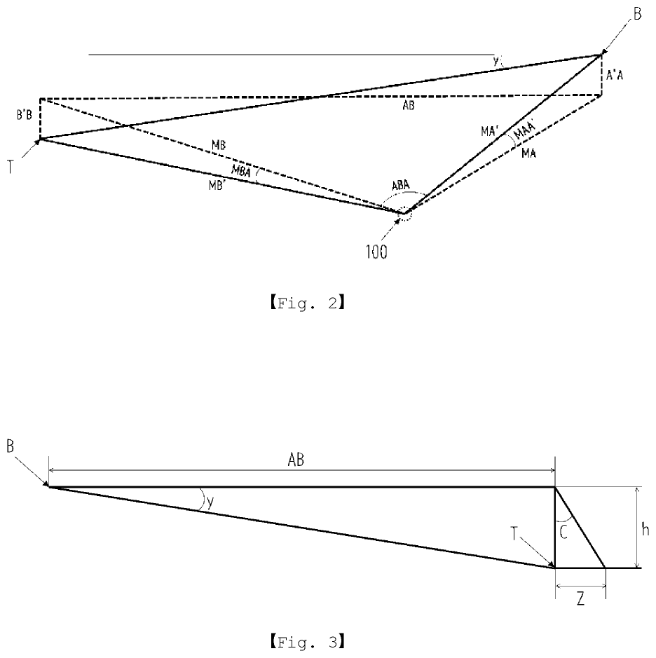

Hereinafter, with reference to FIG. 2, operations of the calculation unit 130 for characteristics up to the ball, calculation unit 140 for characteristics up to the target, and calculation unit 150 for characteristics between the ball and the target will be described.

When a user holds the distance recommendation device 100 and faces a golf ball B, the distance measurement unit 110 of the distance recommendation device 100 measures a straight-line distance MA′ to the golf ball B. In addition, the inclination angle measurement unit 120 may measure an inclination angle MAA to the ball B relative to a horizontal plane on which the inclination angle measurement unit 120 is positioned.

In the example of FIG. 2, it is assumed that MA′ is 48.531 m and MAA is 5.77 degrees.

By using a trigonometric method on the basis of the MA′ value and MAA value, the calculation unit 130 for characteristics up to the ball may calculate a height A′A to the ball, relative to the horizontal plane where the distance recommendation device 100 is positioned, and a horizontal distance MA to the ball. Specifically, each value may be calculated as in Equations 1 and 2 below.

A′A=MA′·sin MAA=48.531 m·sin 5.77°=4.878 m [Equation 1]

MA=MA′·cos MAA=48.531 m·cos 5.77°=48.29 m[Equation2]

Meanwhile, when a user holds the distance recommendation device 100 and faces a target T, the distance measurement unit 110 of the distance recommendation device 100 measures a straight-line distance MB′ to the target T. In addition, the inclination angle measurement unit 120 may measure an inclination angle MBA to the target T, relative to a horizontal plane on which the distance recommendation device 100 is positioned.

In the example of FIG. 2, it is assumed that MB′ is 73.99 m and MAA is −3.10 degrees. The negative MAA refers that the target T is positioned in a downward direction by 3.10 degrees, relative to the horizontal plane.

Meanwhile, in a case where the distance recommendation device 100 according to the exemplary embodiment of the present disclosure is a GPS-based distance recommendation device or a GPS and laser composite-type distance recommendation device, the calculation unit 130 for characteristics up to the ball may obtain absolute position information (e.g., information including latitudes, longitudes, altitudes, etc.) of the ball B.

For example, the position of the current distance recommendation device 100 may be sensed through a GPS satellite signal and the position of the ball B from a current position may be determined on the basis of Equations 1 and 2 above, so, in this way, the absolute position of the ball B may be confirmed.

By using the trigonometric method on the basis of the MB′ value and the MBA value, the calculation unit 140 for characteristics up to the target may calculate a height B′B to the target, relative to the horizontal plane in which the distance recommendation device 100 is positioned, and a horizontal distance to the target MB. Specifically, each value may be calculated as in Equations 3 and 4 below.

B′B=MB′·sin MBA=73.99 m·sin(−3.10°)=−4.000 m [Equation 3]

MB=MB′·cos MBA=73.99 m·cos(−3.10°)=73.88 m[Equation4]

Meanwhile, by way of enabling a user to hold the distance recommendation device 100, face the ball B, and then face the target T, the angle measurement unit 120 may measure, relative to the position of the distance recommendation device 100, a horizontal angle ABA between the ball B and the target T.

In the example of FIG. 2, it is assumed that ABA is 90.23 degrees.

Meanwhile, in a case where the distance recommendation device 100 according to the exemplary embodiment of the present disclosure is the GPS-based distance recommendation device or the GPS and laser composite-type distance recommendation device, the calculation unit 140 for characteristics up to the target may obtain absolute position information (e.g., information including latitudes, longitudes, altitudes, etc.) of the target T.

For example, since the position of the current distance recommendation device 100 may be sensed through a GPS satellite signal and the position of the target T from a current position may be determined on the basis of Equations 3 and 4 above, the absolute position of the target T may be confirmed in this way.

In addition, hole information of each golf course may be stored in a database or other server and the position information of the target T for each hole is stored in such information, so the absolute position of the target T may also be determined by obtaining this information.

According to the exemplary embodiment, since it is sufficient to determine the absolute position of the target T for each case, the distance recommendation device 100 is not required to be positioned at the same point in one case of calculating a position of the ball B and in another case of calculating a position of the target T.

That is, after calculating the position of the ball B through the distance recommendation device 100 in the cart, the user may also move to another position and detect the position of the target T.

On the basis of a horizontal distance MA from a position of the distance recommendation device 100 to a ball B, a horizontal distance MB to a target T, and a horizontal angle ABA between the ball B and the target T, the calculation unit 150 for characteristics between the ball and the target according to the exemplary embodiment may calculate a horizontal distance AB between the ball B and the target T as follows:

$$AB = \sqrt{M {A}^{2} + M {B}^{2} - 2 \cdot MA \cdot MB \cdot cos ABA} = \sqrt{\begin{matrix}{( 48.29 m )}^{2} + {( 73.88 m )}^{2} - 2 \cdot ( 48.29 m ) \cdot \\ ( 73.88 m ) \cdot cos 90.23 °\end{matrix}} = 88.422 m \qquad [ Equation 5 ]$$

Meanwhile, a height B′B-A′A from the ball B to the target T may be calculated on the basis of the height A′A from the current position to the ball B and a height B′B from the current position to the target T, and when these values and the calculated horizontal distance AB(x) between the ball B and the target T are used, an inclination angle y to the target B relative to the ball B may be calculated as follows:

$$y = atan \frac{{B}^{′} B - {A}^{′} A}{A B} = atan \frac{- 4.000 - 4.878}{88.422} = - 5.733 ° \qquad [ Equation 6 ]$$

Meanwhile, the distance recommendation unit 160 according to the exemplary embodiment may calculate a recommended shot distance from the ball B to the target T on the basis of the calculated horizontal distance AB from the ball B to the target T.

Hereinafter, this process will be described with reference to FIG. 3.

First, a user may input reference information through the distance recommendation device 100 or a separate device capable of communicating with the distance recommendation device 100, for example, a separate smart device or the like. Here, the reference information refers to information for determining an angle between a vertical line and a direction in which a golf ball hits the ground after a golfer has made a shot, that is, a landing angle. The landing angle is used to calculate a recommended distance for a shot to send the golf ball to a target.

The reference information may be, for example, a distance at which a golf ball may be sent when a shot is made by using a 7-iron 7i by each golfer. Such reference information may be input by the user or may be preset (e.g., 140 m or 150 m).

The landing angle for each reference information may be obtained on the basis of, for example, information matched in a form of a table, and an example is as follows.

TABLE 1

| Reference information | Landing angle |
|---|---|
| (7-iron distance) (unit: m) | (unit: °) |
| 210 | 53 |
| 200 | 41 |
| 190 | 47 |
| 180 | 44 |
| 170 | 47 |
| 160 | 45 |
| 150 | 44 |
| 140 | 43 |
| 130 | 43 |
| 120 | 43 |
| 110 | 42 |
| 100 | 41 |

The distance recommendation unit 160 calculates a recommended distance for a shot to send a ball to a target by using a height h from the ball B to the target T and a landing angle obtained by referring to the reference information. Since the horizontal distance AB from the ball B to the target T has already been calculated, just an additional distance Z for sending the ball B to the target T is required to be calculated.

This value is calculated as in Equation 7 below.

Z=h·tan C=(B′B=A)·tan C [Equation 7]

h denotes a height from the ball B to the target T, and the height h may be calculated on the basis of the already calculated height A′A from a current position to the ball B and a height B′B to the target T, (i.e., h=B′B—A′A=−4.0 m−4.8 m=−8.8 m).

When the landing angle C is assumed to be 41 degrees, the additional distance Z becomes −7.7 m.

The recommended distance for sending the ball B to the target T is calculated as the sum of the horizontal distance AB from the ball B to the target T and the additional distance Z, and in the above example, 80.7 m (=88.4 m-7.7 m) may be calculated.

Meanwhile, when the distance recommendation device 100 according to the exemplary embodiment of the present disclosure is the GPS-based distance recommendation device or the GPS and laser composite-type distance recommendation device, since the absolute position information of the ball B and the target T may be confirmed as described above, the straight-line distance, horizontal distance, and height from the ball B to the target T may be calculated through this way, and accordingly, the additional distance Z and the recommended distance may be calculated in the same manner as described above.

According to the exemplary embodiment of the present disclosure, even when the user is not in the position of the ball B or the target T, the target distance from the ball B to the target T may be obtained at the third location. In particular, in the case of confirming the positions of the ball B and the target T on the basis of the GPS, there is no problem with that the process of confirming the position of the ball B and the process of confirming the position of the target T are performed at different positions.

Accordingly, a target setting may be enabled from a position of the cart, whereby a correct club may be selectable. Meanwhile, since the golf game spectators are able to obtain the distance information between the ball B and the target T and the target distance information for the accurate shot, the more interesting viewing may be possible.

The above description of the present disclosure is for illustration, and it will be understood that those skilled in the art to which the present disclosure pertains may easily transform the present disclosure in other specific forms without departing from the technical spirit or essential features thereof. Therefore, it should be understood that the above-described exemplary embodiments are illustrative in all respects and not restrictive. For example, each component described as a single type may be implemented in a distributed manner, and similarly, components described as distributed may be implemented in a combined form.

The scope of the present disclosure is indicated by the following claims, and all changes or modifications derived from the meaning and scope of the claims and equivalent concepts should be interpreted as being included in the claims of the present disclosure.

1. A distance recommendation method for golf, as a method for providing a recommended distance from a ball to a target at a third location by a distance recommendation device for the golf, the method comprising:
(a) obtaining position information of the ball positioned in each hole;
(b) obtaining position information of the target positioned in each hole; and
(c) generating a recommended shot distance from the ball to the target on the basis of the obtained information.

2. The method of claim 1, wherein step (a) comprises calculating a horizontal distance to the ball on the basis of measurement information comprising a straight-line distance from a current position to the ball and an inclination to the ball,
step (b) comprises calculating a horizontal distance to the target on the basis of measurement information comprising a straight-line distance from the current position to the target and an inclination to the target, and
step (c) comprises calculating, relative to the current position, a horizontal distance between the ball and the target on the basis of measurement information on an angle between the ball and the target, the horizontal distance to the ball, and the horizontal distance to the target.

3. The method of claim 2, wherein step (c) further comprises:
generating the recommended distance for sending the ball to the target on the basis of a vertical distance from the ball to the target and the horizontal distance between the ball and the target, the vertical and horizontal distances being respectively calculated on the basis of the straight-line distance and inclination to the ball and the straight-line distance and inclination to the target.

4. The method of claim 1, wherein step (a) comprises confirming absolute position information of the ball, and
step (b) comprises confirming absolute position information of the target.

5. A distance recommendation device for golf, the device comprising:
a calculation unit for characteristics up to a ball configured to obtain position information of the ball positioned in each hole;
a calculation unit for characteristics up to a target configured to obtain position information of the target positioned in each hole; and
a distance recommendation unit configured to generate a recommended shot distance from the ball to the target on the basis of the obtained information.
